(19) United States
(12) Patent Application Publication
(10) Pub. No.: US 2008/0304772 A1
(43) Pub. Date: Dec. 11, 2008

(54) Hydrostatic guide system

(75) Inventors: Osamu Kakutani, Oume-shi (JP); Yutaka Kondo, Tachikawa-shi (JP); Shoji Wada, Musashimurayama-shi (JP)

Correspondence Address: Quinn Emanuel Urquhart Oliver & Hedges, LLP;Koda/Androlia, 10th Floor, 865 S. Figueroa Street, Los Angeles, CA, 90017, US

(73) Assignee: Kabushiki Kaisha Shinkawa

(21) Appl. No.: 12/156,758

(22) Filed: Jun. 4, 2008

(30) Foreign Application Priority Data
Jun. 5, 2007 (JP) 2007-149621

(51) Int. Cl. F16C 32/06

(52) U.S. Cl. 384/12

(57) ABSTRACT

A hydrostatic guide system including a guide table, a transfer table, a floating amount sensor attached to the transfer table, and a control unit. The transfer table has an inner portion, in which a magnetic attraction unit including a yoke and an electromagnet is embedded, and an outer shell portion, which covers the side surface and the upper surface of the inner portion. After the inner portion houses the yoke and the electromagnet, a gap around the yoke and the electromagnet is filled with a material having appropriate strength, so that the inner portion is integrated with the outer shell portion, and the transfer surface is flattened as whole. A surrounding groove is provided around the transfer table, and pressurized fluid supplied into the groove is jetted out to the guide table.

### BACKGROUND OF THE INVENTION

1. Field of the Invention

The present invention relates to hydrostatic guide systems and in particular to a hydrostatic guide system capable of supplying pressurized fluid into a gap between a first table and a second table, so that the first and second tables are held with a predetermined floating interval in between.

2. Related Art

A mechanism for supplying pressurized fluid into a gap between a first table and a second table to hold the first table and the second table floating with a predetermined floating interval in between has been known as a fluid bearing mechanism or a hydrostatic bearing mechanism. Using such a hydrostatic bearing mechanism ensures a gap to be produced between the first table and the second table held by the fluid, and the first table and the second table are brought into contact with each other via the fluid instead of solid contact. With this, a friction resistance between the first table and the second table can be greatly reduced. In particular, this allows a guiding apparatus or a moving apparatus to perform guiding or moving drive at a low driving force.

Supplying the pressurized fluid into the gap between the first table and the second table produces a float gap at a point where the weight of the first or second table and a static pressure of the fluid are balanced, for example. However, this is not quite appropriate for a precise guiding apparatus or a precise moving apparatus with which the float gap is required to be precisely controlled, because the stiffness as-is as a bearing is low and the float gap tends to vary. Thus, there has been proposed a device provided for attracting between the first table and the second table and optimizing the attraction, thereby realizing the high stiffness.

For example, Japanese Patent Application Unexamined Publication Disclosure No. H05-71536 discloses a hydrostatic bearing capable of jetting pressurized fluid out to a guiding body such that a moving body floats, and an annular porous body is provided for a housing which faces the guiding body as a magnetic body and is integrated with the moving body, so that the annular porous body surrounds a disc-shaped magnet. Here, the moving body moves away from the guiding body due to the pressurized fluid jetted from the porous body and is attracted toward the guiding body by the magnet.

Moreover, Japanese Patent Application Unexamined Publication Disclosure No. H11-62965 discloses a hydrostatic bearing capable of jetting pressurized fluid against a guiding body such that a moving body floats, and a moving body includes an annular groove surrounding a conductive material portion and from which the pressurized gas is jetted, and a guiding body includes an electrostatic attraction unit that produces an attractive force at the conductive material portion.

Other than the methods disclosed in Japanese Patent Application Unexamined Publication Disclosure Nos. H05-71536 and No. H11-62965, methods using vacuum adsorption have been known in which the first table and the second table are attracted toward each other to float against each other. According to these methods, while the pressurized fluid is supplied into the gap between the first table and the second table, a float gap is controlled to have a certain level of stiffness by balancing and optimizing the gap by an attractive force due to a magnet or electrostatic attraction.

However, in the method disclosed in Japanese Patent Application Unexamined Publication Disclosure No. H05-71536, the annular porous body is provided around the magnet and the pressurized fluid is jetted out from the porous body; as a result, the portion corresponding to the magnet does not constitute a bearing surface, and accordingly, it is not possible to utilize the entire facing surface as a bearing surface. Similarly, in the case that uses the vacuum adsorption, the portion corresponding to holes for vacuum adsorption cannot be used as a bearing surface. When the bearing surface is small, it is not possible to obtain a sufficient stiffness as a fluid bearing. In order to prevent this, the bearing surface must be increased, which requires a magnet with greater power or a higher vacuum, resulting in an increased mass in the bearing.

Furthermore, while the method disclosed in Japanese Patent Application Unexamined Publication Disclosure No. H11-62965 can utilize an entire facing surface as a bearing surface, the electrostatic attraction is significantly reduced to the second power of the size of the gap. Therefore, a large-sized electrostatic device is required in order to obtain a desired attractive force, resulting in an increased mass in the bearing.

### SUMMARY OF THE INVENTION

An object of the present invention is to provide a hydrostatic guide system capable of ensuring a large bearing surface area while utilizing an attractive force produced by a magnet.

The above object is accomplished by a unique structure of the present invention for a hydrostatic guide system for supplying a pressurized fluid into a gap between a first table and a second table, comprising
a predetermined floating interval provided between the first table and the second table by the pressurized fluid; and
the first table comprising
   a surrounding groove provided on a first facing surface that faces the second table, the surrounding groove directing annularly the pressurized fluid that is jetted out of the surrounding groove, and
   a magnetic attraction unit provided in a portion surrounded by the surrounding groove, the magnetic attraction unit magnetically attracting the first table and the second table toward each other.

In the hydrostatic guide system according to the present invention, it is preferable that the first facing surface of the first table, excluding a portion corresponding to the surrounding groove, form a single flat surface.

Moreover, in the hydrostatic guide system according to the present invention, it is preferable that the magnetic attraction unit be embedded in the first table.

In addition, in the hydrostatic guide system according to the present invention, it is preferable that the system further include a floating interval detection unit that detects the interval between the first table and the second table.

Further, in the hydrostatic guide system according to the present invention, it is preferable the second table have a second facing surface that faces the first table, a part of the second facing surface be formed by a magnetic material, and the magnetic attraction portion of the first table preferably includes a permanent magnet.

Moreover, in the hydrostatic guide system according to the present invention, it is preferable that the second table have a second facing surface that faces the first table, a part of the second facing surface be formed by a magnetic material, and the magnetic attraction unit of the first table include an electromagnet.

In addition, in the hydrostatic guide system according to the present invention, it is preferable that the system further include an interval detection unit that detects the interval between the first table and the second table and a float control unit that controls the gap between the first table and the second table to be held at a predetermined floating interval by controlling the electric current that flows through the electromagnet.

Further, in the hydrostatic guide system according to the present invention, it is preferable that
the second table include a second facing surface that faces the first table, and a part of the second facing surface be formed by a magnetic material;
the first table include
   an inner portion formed by a nonmagnetic material and surrounded by the surrounding groove of the first facing surface, and
   an outer shell portion formed, including the surrounding portion where the surrounding groove is provided, by a magnetic material and surrounding the inner portion made of nonmagnetic material; and
the magnetic attraction unit include a permanent magnet or an electromagnet that is magnetically coupled to the outer shell portion.

Moreover, in the hydrostatic guide system according to the present invention, it is preferable that the second table include a drive coil embedded in the second table, and the system further include a drive control unit that controls a relative movement of the first table and the second table by controlling the electric current that flows through the drive coil.

In addition, in the hydrostatic guide system according to the present invention, it is preferable that the pressurized fluid supplied into the gap between the first table and the second table be pressurized gas or pressurized liquid.

According to at least one of the above-described structures, the surrounding groove within which the pressurized fluid annularly directed is provided on the first facing surface of the first table of the hydrostatic guide system, and the magnetic attraction unit is provided inside the first table at a portion surrounded by the surrounding groove. Accordingly, the first facing surface of the first table as a whole can be used as a bearing surface that includes a portion where the magnetic attraction unit is provided except for the portion corresponding to the surrounding groove, and it is possible to secure a large area for the bearing surface.

Further, in the hydrostatic guide system of the present invention, the first facing surface of the first table excluding a portion corresponding to the surrounding groove constitutes a single flat surface. Accordingly, the first facing surface as a whole can be used as the bearing surface.

Further, in the hydrostatic guide system of the present invention, the magnetic attraction unit is provided so as to be embedded in the first table. Accordingly, the first facing surface can easily form an integrated flat surface.

Further, in the hydrostatic guide system of the present invention, the first floating interval detection unit that detects the interval between the first table and the second table is provided. Accordingly, it is possible to correctly detect the floating interval and control the floating interval using the detected interval so as to control, for example, the pressure of the pressurized fluid, thereby realizing an infinite stiffness in appearance in the first table (infinite stiffness here being a quasi-infinite stiffness in the first table when the first table is held, under a certain amount of set load, with a predetermined interval from the second table).

Further, in the hydrostatic guide system of the present invention, the second table has the second facing surface that faces the first table, and a portion of the second facing surface is formed by a magnetic material; and the magnetic attraction unit of the first table includes a permanent magnet. Accordingly, it is possible to keep the floating interval within a predetermined range by balancing the attraction between the permanent magnet and the second table and the floating force of the pressurized fluid.

Further, in the hydrostatic guide system of the present invention, the second table has the second facing surface that faces the first table, and a portion of the second facing surface is formed by a magnetic material; and the magnetic attraction unit of the first table includes an electromagnet. Accordingly, it is possible to keep the floating interval within a predetermined range by balancing the attraction between the electromagnet and the second table and the floating force of the pressurized fluid.

Further, in the hydrostatic guide system of the present invention, the electric current that flows through the electromagnet is controlled by using the floating interval detection unit so as to control the interval between the first table and the second table to be a predetermined floating interval. Accordingly, an infinite stiffness in appearance can be realized in the first table.

Further, in the hydrostatic guide system of the present invention, the second table includes a second facing surface that faces the first table, and the portion corresponding to the second facing surface is formed by the magnetic material; and the first table includes an inner portion, which is formed by a nonmagnetic material and surrounded by a surrounding groove, and a surrounding portion, which is where the surrounding groove is provided, and an outer shell portion surrounding the inner portion made of the nonmagnetic material is formed by a magnetic material. In addition, either a permanent magnet or an electromagnet that is magnetically coupled to the outer shell portion is provided. Accordingly, the portion of magnetic material in the first table serves as a yoke, thereby simplifying the structure.

Further, in the hydrostatic guide system of the present invention, the second table includes a drive coil embedded in the second table, and the system controls the relative movement of the first table and the second table by controlling the electric current that flows through the drive coil. Because the first table and the second table float due to a fluid bearing mechanism, it is possible to reduce the friction to realize a smooth movement between the first table and the second table.

### BRIEF DESCRIPTION OF THE DRAWINGS

FIG. 1 is a cross sectional view illustrating a structure of the hydrostatic guide system of one embodiment according to the present invention;

FIG. 2 is a bottom view illustrating the transfer table, viewed from the bottom side of the embodiment according to the present invention.

FIG. 3 illustrates a variation of the transfer table of the embodiment according to the present invention;

FIG. 4 is a cross sectional view illustrating a structure of the hydrostatic guide system of a different embodiment of the present invention; and

FIG. 5 illustrates a variation of the hydrostatic guide system of the different embodiment.

### DETAILED DESCRIPTION OF THE INVENTION

Embodiments of the present invention will be described in detail with reference to the accompanying drawings. In the following description, a first table is referred to as a transfer table, a second table is referred to as a guide table, a pressurized fluid is supplied from the transfer table side, and a magnetic attraction unit is provided on a transfer table side. Nonetheless, in the present invention, the pressurized fluid can be supplied from the guide table side, and the magnetic attraction unit can be provided on the transfer table side, when possible.

Further, in the following description, the transfer table is movable with respect to the guide table in a guide plane of the guide table, and a hydrostatic guide system is explained to include a drive mechanism for this movement of the transfer table. However, the guide table can be formed in a tubular shape, in which the transfer table in a cylindrical shape is provided, and the transfer table is movable only in the axial direction along the tube of the guide table. In this case, a fluid bearing mechanism serves as a so-called radial bearing that bears the load in a radial direction.

Moreover, while the following description is made on an example in which a bonding head including a bonding tool is mounted on the transfer table, components other than the bonding head can also be mounted on the transfer table. In addition, in the following description, a magnetic attraction unit provided in the transfer table has a structure that includes a yoke and an electromagnet and a structure that uses a yoke and a permanent magnet. This is merely because such structures are easier to explain for illustrative purposes, and it should be noted that the electromagnet in the former structure can be a permanent magnet, and the permanent magnet in the latter structure can be an electromagnet. Furthermore, the materials and sizes in the following description are mere examples for illustrative purposes only, and they can be changed appropriately according to, for instance, the specification of a hydrostatic guide system.

### First Embodiment

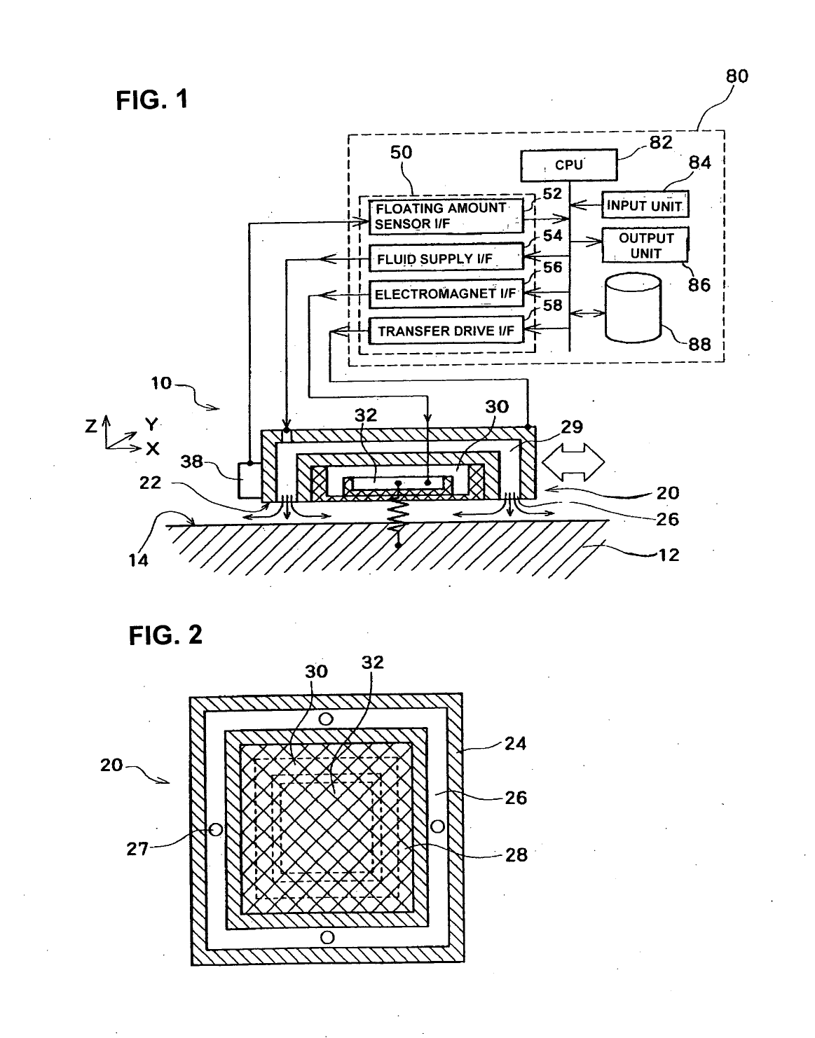

FIG. 1 is a structural diagram of a hydrostatic guide system 10 used for a bonding apparatus. In FIG. 1, a transfer table 20 that is a part of the hydrostatic guide system 10 is illustrated in a cross sectional view. FIG. 2 shows a bottom view of the transfer table 20 of the hydrostatic guide system 10, when viewed from the bottom side.

The hydrostatic guide system 10 is comprised of the transfer table 20, a mechanism section including a guide table 12, and a control unit 80 that controls the components of the mechanism section to operate. The control unit 80 includes a computer and an interface unit 50 provided between and connected to the mechanism section and the computer. The interface unit 50 includes various sensing circuits, various driving circuits, various fluid control units, and such, each for operating the components of the mechanism section according to the instructions from the computer.

In FIG. 1, a CPU 82, an input unit 84, an output unit 86, and a storage device 88 are shown as the components of the computer. FIG. 1 also shows a floating amount sensor I/F 52, a fluid supply I/F 54, an electromagnet I/F 56, and a transfer drive I/F 58, as the interface unit 50. These components are connected to each other via an internal bus.

In the following, each component of the mechanism section including the transfer table 20 and the guide table 12 will be first described, and then the control unit 80 will be described.

The hydrostatic guide system 10 has a function of supplying pressurized fluid into a gap between the transfer table 20 and the guide table 12 to hold the transfer table 20 and the guide table 12 in a floating fashion with a predetermined floating interval in between. This function is referred to as a fluid bearing function or a hydrostatic bearing function. The direction of floating is a Z direction as shown in FIG. 1.

The hydrostatic guide system 10 has a further function of moving the transfer table 20 to a given position within the guide plane of the guide table 12 and positioning the moved transfer table at this given position. The guide plane of the guide table 12, i.e. a transfer plane, is an X-Y plane as shown in FIG. 1. Mounted on this transfer table 20 of the hydrostatic guide system 10 is a bonding head including a bonding tool that is not shown in FIG. 1. Thus, the hydrostatic guide system 10 is an apparatus that functions to reduce the frictional force and move the bonding head to given positions within the X-Y plane and to position the moved bonding head at a particular given position.

The hydrostatic guide system 10 includes, in its mechanism section, the guide table 12 and the transfer table 20, and it further includes a floating amount sensor 38 attached to the transfer table 20. The transfer table 20 is supplied with a pressurized fluid through the fluid supply I/F (interface) 54 of the control unit 80, is controlled to electromagnetically float by the electromagnet I/F 56, and is driven to move within the X-Y plane by the transfer drive I/F 58. Detection data from the floating amount sensor 38 is transmitted to the control unit 80 via the floating amount sensor I/F 52 and used for controlling the amount of floating.

The guide table 12 is a stage table having a function to hold the transfer table 20 by a hydrostatic bearing mechanism. Therefore, the guide table 12 and the transfer table 20 respectively have surfaces that constitute a pair of facing surfaces that face each other, and a pressurized fluid is supplied into the gap between the two facing surfaces to form a hydrostatic bearing. As described above, the guide table 12 and the transfer table 20 form a pair when these tables form a hydrostatic bearing, and accordingly, the each one of the tables can be generally referred to as a first table and a second table. For example, when the transfer table 20 of the pair is a first table, then the guide table 12 is a second table of the pair.

The facing surface of the guide table 12 that faces the transfer table 20 is a guide surface 14. Because the guide surface 14 receives the pressurized fluid jetted out from the transfer table 20, the guide surface 14 in that sense is a fluid receiving surface. Further, the guide surface 14 of the guide table 12 also has a function of guiding planar movement of the transfer table 20 within the plane of the guide surface 14, and accordingly, the guide surface 14 in that sense is a movement guiding surface. Thus, the guide surface 14 is finished with a smaller flatness than the float gap of the hydrostatic bearing mechanism. For example, when the float gap of the hydrostatic bearing mechanism is about 10 μm, the overall flatness including recesses, projections, and curves of the guide surface 14 over the entire area in which the transfer table 20 moves is preferably smaller than a few μm.

As the guide table 12 described above, a member made of a metal magnetic material that has been machined to have a flat finish surface can be used. As the metal magnetic material, a magnetic body among tool steel and stainless steel, for example, can be used. It should be noted that a portion required to be formed by a metal magnetic material is a part of the surface portion that includes the guide surface 14 where the thickness is appropriate. Portions other than this portion can be made from a material with appropriate mechanical strength, instead of a metal magnetic material.

As described above, the transfer table 20 together with the guide table 12 forms a pair to form a hydrostatic bearing mechanism; and the transfer table 20 is provided with a surrounding groove 26 that annularly guides the pressurized fluid to be jetted out evenly to the guide surface 14 of the guide table 12, and it is further provided with a yoke 30 and an electromagnet 32 that magnetically attract the guide table 12 and the transfer table 20 toward each other.

The transfer table 20 includes a transfer surface 22 that faces toward the guide surface 14 of the guide table 12. The transfer surface 22 faces the guide surface 14 and forms a fluid gap therebetween into which the pressurized fluid is supplied. The transfer surface 22 in that sense is a fluid supplying surface. Further, the transfer surface 22 of the transfer table 20 is guided by the guide surface 14 as it moves within the X-Y plane shown in FIG. 1. The transfer surface 22 in that sense is called a transfer surface. Thus, similarly to the guide surface 14, the transfer surface 22 of the transfer table 20 is finished with a smaller flatness than the float gap of the hydrostatic bearing mechanism, and it is preferable that, as described above, when the float gap of the hydrostatic bearing mechanism is about 10 μm, an overall flatness including recesses, projections, and curves of the transfer surface 22 be smaller than a few μm over its entire area.

As shown in FIG. 1 and FIG. 2, the transfer table 20 is generally comprised of three parts: an outer shell portion 24, an inner portion 28, and a magnetic attraction unit that includes the yoke 30 and the electromagnet 32.

The outer shell portion 24 is constituted from a surrounding portion, where the surrounding groove 26 opens in the transfer surface 22, and an upper surface portion, which is on the opposite side of the transfer surface 22 or on the upper surface side when viewing the transfer surface 22 from the lower surface side or from below. In other words, the outer shell portion 24 covers the side surfaces and the upper surface of the inner portion 28, thus forming the surrounding groove 26 in between. FIG. 2 shows the outer shell portion 24 by slanted lines drawn from upper left to lower right.

The surrounding groove 26 is a surrounding portion of the outer shell portion 24 to surround the inner portion 28, and it is a groove having a constant width and depth provided for the transfer surface 22. Holes 27 are formed in the bottom portion (upper side in FIG. 1) of the surrounding groove 26, and these holes 27 are opened to a pressurized fluid channel 29 provided within the transfer table 20. The pressurized fluid channel 29 is an internal pipeline in the transfer table 20, through which the pressurized fluid is supplied by the fluid supply I/F 54. The pressurized fluid supplied into the pressurized fluid channel 29 is directed toward the surrounding groove 26 through the holes 27 and jetted out evenly to the guide surface 14 of the guide table 12 from the surrounding groove 26.

The surrounding groove 26 may have a shape other than the shape shown in FIG. 2, as long as the surrounding groove 26 is provided annularly along the outer shell portion 24. For example, the surrounding groove 26 can be a groove provided along the outer shell portion 24 in a circular shape in plan view, a groove provided along the outer shell portion 24 in an elliptic shape in plan view, or a groove provided along the outer shell portion 24 in a polygonal shape in plan view. Further, the surrounding groove 26 is not necessarily closed in plan view as long as it is provided in the inner portion of the outer shell portion 24. For example, the surrounding groove 26 can be a spiral in plan view with both ends not connected to each other. Moreover, depending on applications, the surrounding groove 26 does not necessarily extend along the entire part of the outer shell portion 24, and a part of the groove can be not formed. In addition, the surrounding groove 26 can be formed from a plurality of fluid jet holes discretely provided so as to annularly extend along the outer shell portion 24 as long as the pressurized gas is jetted out along the outer shell portion 24.

The surrounding groove 26 is for allowing the pressurized fluid to jet out to the guide surface 14 of the guide table 12. Thus, the surrounding groove 26 can have a function such as an inherent restrictor or an orifice restrictor. For example, in FIG. 1, the holes 27 are for jetting out the pressurized fluid from the pressurized fluid channel 29 toward the surrounding groove 26 and correspond to so-called inherent restrictors or orifice restrictors. Further, in the above example including the discretely provided plurality of fluid jet holes, the plurality of holes can be considered as an inherent restrictor group or an orifice restrictor group.

As the outer shell portion 24 described above, a member made of a nonmagnetic material with appropriate strength that has been machined to have a flat finish surface can be used. As the nonmagnetic material with appropriate strength, it is preferable to use a nonmagnetic metal material. For example, aluminum or nonmagnetic stainless steel machined into a desired shape can be used as the outer shell portion 24.

The inner portion 28 is a portion of the transfer table 20 surrounded by the outer shell portion 24. The inner portion 28 serves as a housing space for housing the yoke 30 and the electromagnet 32 as the magnetic attraction unit within the transfer table 20. Further, the inner portion 28 also has a function of, after housing the yoke and the electromagnet 32, filling a gap around the yoke 30 and the electromagnet 32 with a material with appropriate strength, thereby integrating the yoke and electromagnet 32 with the outer shell portion 24. The portion where the filling is made is shown by hatching in FIG. 1 and FIG. 2. Especially important points about the integration are that the outer shell portion 24 and the inner portion 28 are joined so as not to be separated at an interface (joined areas) therebetween and that an interface (joined areas) between the outer shell portion 24 and the inner portion 28 in the transfer surface 22 is made flat without any recesses or projections. As described above, an allowance of the recesses or projections is required to be below the size of the float gap between the guide table 12 and the transfer table 20.

A nonmagnetic material is used as a material for the inner portion 28, because the inner portion 28 is provided with the magnetic attraction unit therein. For example, a ceramic material, resin material, and nonmagnetic metal material, among others, can be used. When using a resin material, the magnetic attraction unit is first provided in the housing space corresponding to the inner portion 28, and then the resin material is filled within the housing space using an appropriate resin molding technique, thus molding integrally with the outer shell portion 24. It is preferable that, for example, appropriate recesses and projections be provided within the outer shell portion 24, thereby increasing the bonding strength in the integral molding. Surfaces of the outer shell portion 24 and inner portion 28 are grinded or polished after the integral molding, thus finishing the transfer surface 22 into a single flat surface.

As seen from the above, the transfer surface 22 as a whole is finished as a single flat surface, and the surrounding groove 26 is provided as a recess for the surrounding portion of the transfer surface 22; accordingly, the pressurized fluid jetted out to the guide surface 14 from the surrounding groove 26 cannot go anywhere but remains within the inner region surrounded by the surrounding groove 26 at a certain pressure. More specifically, the pressure of the pressurized fluid is also supplied in the inner region surrounded by the surrounding groove 26 in the gap where the transfer surface 22 of the transfer table 20 and the guide surface 14 of the guide table 12 face each other, and the inner region along with the surrounding portion for which the surrounding groove 26 is provided forms a bearing surface of the hydrostatic bearing mechanism. In this manner, by finishing the entire transfer surface 22 of the transfer table 20 as a single flat surface and by providing the surrounding groove 26, into which the pressurized fluid is directed, for the surrounding portion of the transfer surface 22, the entire transfer surface 22 excluding a portion corresponding to the surrounding groove 26 can be used as the bearing surface of the hydrostatic bearing mechanism.

The yoke 30 and the electromagnet 32 form the magnetic attraction unit. The yoke 30 is a magnetic path component that is magnetically coupled to the electromagnet 32, and its end portion is facing the transfer surface 22 side of the transfer table 20. The yoke 30 has a function of directing the magnetic flux produced by the electromagnet 32 toward the transfer surface 22 side and forming a magnetic circuit along with the guide table 12 that is provided to face the transfer surface 22. As the yoke 30, a magnetic material formed in an appropriate shape can be used. The electromagnet 32 is a magnetic flux producing device having an exciting coil, and, if necessary, an iron core.

In FIG. 1, the floating amount sensor 38 serves as a sensor for detecting the interval of the gap between the transfer surface 22 and the guide surface 14. As the floating amount sensor 38, an appropriate position sensor such as a capacitance, magnetic, or an optical position sensor and such can be used. Detection data of the interval of the gap is transmitted to the control unit 80. While FIG. 1 shows only one floating amount sensor 38 that detects a floating interval between the transfer table 20 and the guide table 12, more than one floating amount sensors 38 can be used according to the size of the transfer table 20 and required accuracy.

Now, the control unit 80 will be described below in detail. The control unit 80 includes, as described above, the CPU 82, the input unit 84 such as a keyboard and a switch, the output unit 86 such as a display, the storage device 88 that stores programs, etc., and the interface unit 50. These components are connected to each other via an internal bus. A control device in which a computer connected with various appropriate interface boards can be used as the control unit 80. A function to control the operation of the mechanism section via the interface unit 50 can be realized by software, specifically, by running a hydrostatic guide program. A part of the control function can be realized by hardware.

The electromagnet I/F 56 of the interface unit 50 includes a coil driving circuit having a function of flowing current through an exciting coil of the electromagnet 32. More specifically, the electromagnet I/F 56 can be, for instance, an appropriate current amplifier. The electromagnet I/F 56 is connected to the CPU 82 via the internal bus and operates under the instructions of the CPU 82.

When the electric current flows through the exciting coil of the electromagnet 32 by the electromagnet I/F 56, the magnetic flux is produced. The produced magnetic flux is directed toward the transfer surface 22 side by the yoke 30. Then, the magnetic flux is directed from one end of the yoke 30 toward the guide table 12 made of a magnetic material, and then returned to the exciting coil of the electromagnet 32. In this manner, the magnetic flux produced by the electromagnet 32 flows through the magnetic circuit formed by the yoke 30 and the guide table 12. As a result, the magnetic attraction works so as to reduce the gap between the transfer surface 22 and the guide surface 14.

The pressure of the pressurized fluid supplied to the gap between the transfer surface 22 and the guide surface 14 works to increase the gap between the transfer surface 22 and the guide surface 14. Therefore, by balancing the fluid pressure and the magnetic attraction, the interval between the transfer surface 22 and the guide surface 14 can be controlled to be the predetermined floating interval.

The fluid supply I/F 54 of the interface unit 50 is a fluid control unit having a function to supply the pressurized fluid into the pressurized fluid channel 29 of the transfer table 20. More specifically, the fluid supply I/F 54 is comprised of a pressurized fluid source and a regulator. The regulator of the fluid supply I/F 54 is a fluid adjustment device that adjusts at least one of the fluid pressure and a flow rate of the pressurized fluid, and it can be an appropriate fluid control valve, for example. The fluid supply I/F 54 is connected to the CPU 82 via the internal bus and operates under the instructions of the CPU 82.

The transfer drive I/F 58 has a function of driving the transfer table 20 to move with respect to the guide table 12 to a given position within a plane of the guide surface 14 and positioning the moved transfer table 20 at this given position. More specifically, the transfer drive I/F 58 is comprised, for example, of an actuator, such as a step motor or a linear motor, and an actuator driving circuit, and it can include a position detection sensor. The transfer drive I/F 58 is connected to the CPU 82 via the internal bus and operates under the instruction of the CPU 82.

As described above, the control unit 80 has a function of controlling the operations of other components of the hydrostatic guide system 10 via the interface unit 50 in an overall manner. In other words, the control unit 80 has a float control function that controls the interval between the guide surface 14 and the transfer surface 22 to be a predetermined floating interval. Further, the control unit 80 has a drive control function to drive the transfer table 20 to move to a given position within the X-Y plane and positioning the moved transfer table 20 at this given position.

The float control function of the control unit 80 is to adjust at least one of the fluid pressure and flow rate of the pressurized fluid at the fluid supply I/F 54 based on the detection data by the floating amount sensor 38, thereby controlling the interval between the guide surface 14 and the transfer surface 22 to be a predetermined floating interval by taking balance of the interval of the gap with the magnetic attraction of the electromagnet 32. For example, when the interval of the gap is smaller than the predetermined floating interval according to the detection data of the floating amount sensor 38, that is, when the amount of floating is not sufficient, the fluid pressure of the pressurized fluid is increased by the fluid supply I/F 54. In other words, the flow rate of the pressurized fluid is increased. In contrast, when the interval of the gap is greater than the predetermined floating interval according to the detection data of the floating amount sensor 38, that is, when the amount of floating is excessively large, the fluid pressure of the pressurized fluid is reduced by the fluid supply I/F 54, or the flow rate of the pressurized fluid is reduced.

As described above, by feeding back the detection data from the floating amount sensor 38 to the fluid supply I/F 54 to finely control the fluid control valve, the interval of the gap between the guide surface 14 and the transfer surface 22 can be controlled to be the predetermined floating interval. Alternately, it is possible that amounts of adjustment of the fluid control valve corresponding to amounts of deviation from a predetermined floating interval are stored in advance by, for instance, mapping, and the amount of deviation of the interval of the gap from the predetermined floating interval is obtained according to the detection data from the floating amount sensor 38, and then the fluid control valve is adjusted at the fluid supply I/F 54 by referring to the map.

The drive control function of the control unit 80 is for driving the transfer table 20, according to an instruction for a movement position from an input unit that is not shown in the drawing, to move with respect to the guide table 12 to a position corresponding to the instructed position by the transfer drive I/F 58. More specifically, the control is performed by operating the actuator by a drive signal supplied to the driving circuit corresponding to the actuator included in the transfer drive I/F 58. For example, when the actuator is constituted by an X step motor for driving in an X direction and a Y step motor for driving in a Y direction, the X and Y coordinates of the difference between a current position and a target position is calculated from the movement position instruction. Then, a step pulse corresponding to the calculated difference in the X coordinate is supplied to the X step motor, and a step pulse corresponding to the calculated difference in the Y coordinate is supplied to the Y step motor. By actuating the actuator in this manner, it is possible to control the transfer table 20 to move to a desired position.

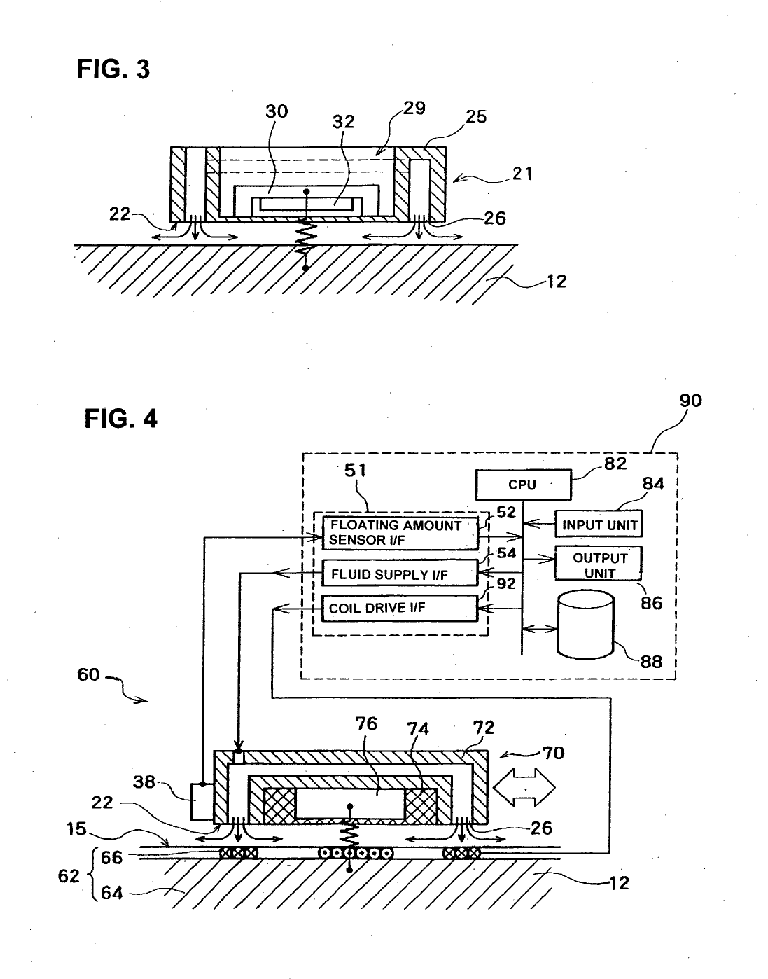

FIG. 3 shows a variation of the structure of the transfer table. In the following description, like components as those shown in the FIG. 1 and FIG. 2 are indicated by like reference numerals, and detailed description of such components are omitted. Further, in the following description, the same reference numerals as those used in FIG. 1 and FIG. 2 will be used. In FIG. 1 and FIG. 2 as shown above, the electromagnet 32 and the yoke 30 are housed in the housing space opening on the side of the transfer surface 22 in the outer shell portion 24 of the transfer table 20. In other words, the outer shell portion 24 remains opened on the transfer surface 22 side until the electromagnet 32 and the yoke 30 are installed within the housing space and the nonmagnetic material is filled in the housing space.

The transfer table 21 shown in FIG. 3 has an outer shell portion 25 that is formed by a nonmagnetic body. In this case, the opening for housing the electromagnet 32 and the yoke 30 does not open on the transfer surface 22 side. Instead, an opening for housing the electromagnet 32 and the yoke 30 opens in a portion opposite from the transfer surface 22, that is, on the upper surface side when viewing the transfer surface 22 as a lower surface.

In FIG. 3, the outer shell portion 25 is structured such that its transfer surface 22 is formed as an integral single flat surface except the surrounding groove 26. Accordingly, while flattening step of the transfer surface 22 must be taken after integrating the outer shell portion 24 by filling the material for the inner portion 28 in the structure shown in FIG. 1 and FIG. 2, in the structure shown in FIG. 3, a step for flattening the transfer surface 22 is only necessary when forming the outer shell portion 25. In other words, the transfer surface 22 is flattened before the electromagnet 32 and the yoke 30 are housed in the outer shell portion 25. Thus, it is possible to easily flatten the transfer surface 22.

### Second Embodiment

The above-described example shown in FIG. 1 and other drawings, the yoke is provided within the transfer table, and the outer shell portion of the transfer table is formed by a nonmagnetic body. However, by structuring the outer shell portion with a magnetic body, the outer shell portion can be used as a yoke for the magnetic attraction unit. FIG. 4 is a cross sectional view illustrating a hydrostatic guide system 60 having such a structure. In the following description, like components as those shown in FIG. 1 through FIG. 3 are indicated by like reference numerals, and detailed description of such components are omitted. Further, in the following description, the same reference numerals as those used in FIG. 1 through FIG. 3 will be used.

Because the electromagnet 32 is omitted and a transfer table 70 is driven to move by a drive coil 66 as described in detail later, thus being different from FIG. 1, the control unit 90 has an interface unit 51 that has a structure different from the one shown in FIG. 1. More specifically, the interface unit 51 includes a coil drive I/F 92 in addition to the floating amount sensor I/F 52 and the fluid supply I/F 54.

In the hydrostatic guide system 60 shown in FIG. 4, the transfer table 70 is constituted from an outer shell portion 72 and an inner portion 74. Further, a guide table 62 includes a guide table main body 64 formed by a magnetic material, and the drive coil 66 is provided on the upper surface side of the guide table main body 64. The drive coil 66 is embedded in the nonmagnetic material and flattened on its upper surface, and this flatted surface forms a guide surface 15. In other words, the guide table 62 has a dual structure comprising the guide table main body 64 formed by a magnetic material and a nonmagnetic body layer in which the drive coil 66 is embedded.

The outer shell portion 72 is formed by a magnetic material. Similarly to FIG. 1, the outer shell portion 72 has an opening portion on the transfer surface 22 side, and also similarly to FIG. 1, its opening portion is filled to form the inner portion 74. The portion corresponding to the filling of nonmagnetic material is made is shown by hatching in FIG. 4. Accordingly, the integration of the outer shell portion 72 and the inner portion 74 as well as the integral flattening of the transfer surface 22 are the same as those described with reference to FIG. 1. As a material for the outer shell portion 72, it is preferable to use a metal magnetic material having appropriate strength. For example, tool steel or stainless steel having a magnetic property and machined into a desired shape can be used as the outer shell portion 72.

The inner portion 74 is a portion in the transfer table 70 and surrounded by the outer shell portion 72. The inner portion 74 serves as a housing space for housing a permanent magnet 76 inside the transfer table 70, and it has such a function that, after housing the permanent magnet 76, a gap space around the permanent magnet 76 is filled with a material having appropriate strength, thereby integrating with the outer shell portion 72. As a material for this, a nonmagnetic material is used because the permanent magnet 76 is provided in the inner portion 74. For example, a ceramic material, a resin material, a nonmagnetic metal material can be used.

The permanent magnet 76 has a function to produce a magnetic flux, and it forms, along with the outer shell portion 72 made of magnetic material, a magnetic attraction unit. Thus, the permanent magnet 76 is provided so that it is magnetically coupled to the outer shell portion 72.

The magnetic flux produced by the permanent magnet 76 is directed toward the transfer surface 22 side by the outer shell portion 72 that serves as a yoke. Then, the magnetic flux is directed from one end of the surrounding portion of the outer shell portion 72 toward the guide table 62 formed by a magnetic material and then returned to the permanent magnet 76. In this manner, the magnetic flux produced by the permanent magnet 76 flows through a magnetic circuit formed by the guide table 62 and the outer shell portion 72 that serves as the yoke. As a result, the magnetic attraction works so as to reduce the gap between the transfer surface 22 and the guide surface 15.

As described above, the guide table 62 has a dual structure comprising the guide table main body 64, which is formed by a magnetic material, and the nonmagnetic body layer, in which the drive coil 66 is embedded. The drive coil 66 is provided such that a conductive wire is wound within a plane parallel to the guide surface 15 between a position that correspond to the surrounding portion of the outer shell portion 72 of the transfer table 70 and a position that corresponds to a center portion of the outer shell portion 72. The conductive wire is wound in such a direction that, as shown in FIG. 4, the driving force is directed along a direction that is parallel to the guide surface; wherein this driving force is produced due to an interaction between the magnetic flux, which flows between the transfer table 70 and the guide table 62 when the outer shell portion 72 works as the yoke, and the electric current, which flows through the conductive wire of the drive coil 66. The drive coil 66 is connected to the coil drive I/F 92.

In this structure, the coil drive I/F 92 of the control unit 90 includes a coil driving circuit that supplies drive current to the drive coil 66. Such a coil driving circuit can be formed by, for example, an appropriate current amplifier. The coil drive I/F 92 is connected to the CPU 82 via the internal bus and operates under the instructions of the CPU 82.

As described above, the drive coil 66 has a function for driving the transfer table 70 with respect to the guide table 62 so that the transfer table 70 is moved within the plane parallel to the guide surface 15, using the magnetic flux that flows between the transfer table 70 and the guide table 62 when the outer shell portion 72 works as the yoke. In other words, the drive coil 66 corresponds to the stator of a linear motor, and the outer shell portion 72 serving as the yoke corresponds to the mover of a linear motor.

As described above, with the use of the guide table 62 having the drive coil 66 embedded therein, it is possible to drive the transfer table 70 to move to a given position by the magnetic flux that flows between the transfer table 70 and the guide table 62 and by the drive current flowing through the drive coil 66 by the coil drive I/F 92 under the control of the control unit 90.

In the structure of FIG. 1 as well, it is possible to drive the transfer table 20 to move with respect to the guide table 12 using the magnetic flux that flows between the yoke 30 and the guide table 12 by embedding a drive coil in the guide table 12. However, in the structure of FIG. 1, because the yoke 30 is positioned inside the inner portion 28, the driving force for movement is produced in the vicinity of the center portion of the transfer table 20. In contrast, in the structure of FIG. 4, the driving force for movement is produced in a peripheral portion of the transfer table 70 because the outer shell portion 72 serves as a yoke, and therefore it is easier to secure a space for winding a coil.

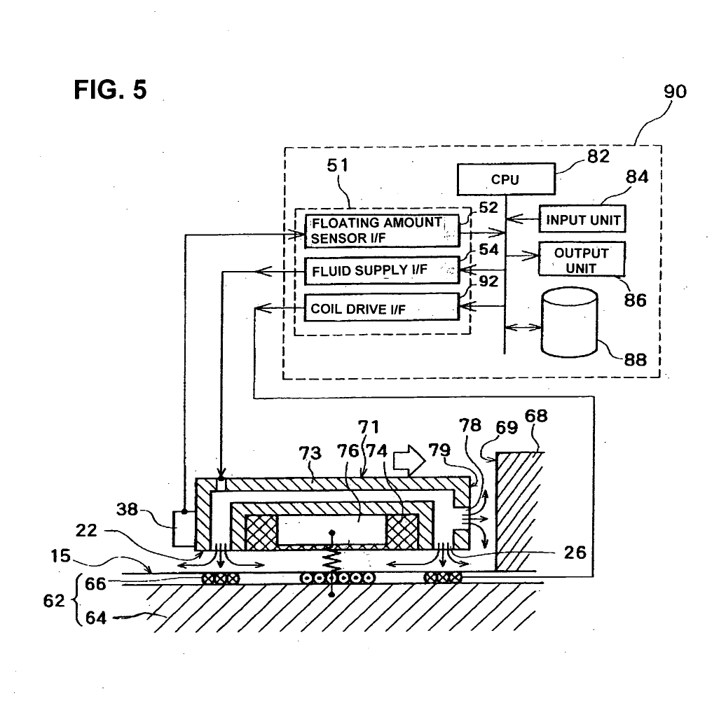

FIG. 5 shows another variation of the structure of the transfer table. In the following description, like components as those shown in FIG. 1 through FIG. 4 are indicated by like reference numerals, and a detailed description of such components will be omitted. Further, in the following description, the reference numerals used in FIG. 1 through FIG. 4 will be used. FIG. 5 shows a structure in which the driving movement by the drive coil 66 is restricted by a side wall 68. In this case, outlets 78 for jetting the pressurized fluid out are also provided in the side wall of the outer shell portion 73 of a transfer table 71, so that the pressurized fluid is supplied, through the outlets 78, into the gap between the side wall surface 69 of the side wall 68 and the side wall surface 79 of the transfer table 71. With this structure, it is possible to realize a uniaxial guiding in a direction vertical to the plane of the drawing sheet for FIG. 5.

What is claimed is:

1. A hydrostatic guide system for supplying a pressurized fluid into a gap between a first table and a second table, comprising:
a predetermined floating interval provided between the first table and the second table by the pressurized fluid; and
the first table comprising
a surrounding groove provided on a first facing surface thereof that faces the second table, the surrounding groove directing annularly the pressurized fluid that is jetted out of the surrounding groove, and
a magnetic attraction unit provided in a portion surrounded by the surrounding groove, the magnetic attraction unit magnetically attracting the first table and the second table toward each other.

2. The hydrostatic guide system according to claim 1, wherein
the first facing surface of the first table, excluding a portion corresponding to the surrounding groove, forms a single flat surface.

3. The hydrostatic guide system according to claim 1, wherein
the magnetic attraction unit is embedded in the first table.

4. The hydrostatic guide system according to claim 1, further comprising:
a floating interval detection unit for detecting an interval between the first table and the second table.

5. The hydrostatic guide system according to claim 1, wherein
the second table has a second facing surface facing the first table, and a part of the second facing surface is formed by a magnetic material, and
the magnetic attraction unit of the first table includes a permanent magnet.

6. The hydrostatic guide system according to claim 1, wherein
the second table has a second facing surface facing the first table, and a part of the second facing surface is formed by a magnetic material, and
the magnetic attraction unit of the first table includes an electromagnet.

7. The hydrostatic guide system according to claim 6, further comprising:
an interval detection unit for detecting an interval between the first table and the second table; and
a float control unit for controlling the first table and the second table to be held floating with a predetermined floating interval by controlling electric current that flows through the electromagnet.

8. The hydrostatic guide system according to claim 1, wherein
the second table has a second facing surface facing the first table, and a part of the second facing surface is formed by a magnetic material,
the first table includes
an inner portion formed by a nonmagnetic material and surrounded by the surrounding groove of the first facing surface, and
an outer shell portion formed, including a surrounding portion where the surrounding groove is provided, by a magnetic material and surrounding the inner portion made of nonmagnetic material, and
the magnetic attraction unit of the first table comprises one of a permanent magnet and an electromagnet that is magnetically coupled to the outer shell portion.

9. The hydrostatic guide system according to claim 1, wherein
the second table includes a drive coil embedded in the second table, and
the system further includes a drive control unit that controls relative movement between the first table and the second table by controlling electric current that flows through the drive coil.

10. The hydrostatic guide system according to claim 1, wherein
the pressurized fluid supplied into the gap between the first table and the second table is one of pressurized gas and pressurized liquid.
